(19) United States
(12) Patent Application Publication
(10) Pub. No.: US 2020/0138121 A1
(43) Pub. Date: May 7, 2020

(54) "Hankz Tuckable Tissue" Handkerchief System and Method of Using the System

(71) Applicant: Justin Earl Bird, Houston, TX (US)

(72) Inventor: Justin Earl Bird, Houston, TX (US)

(21) Appl. No.: 16/608,828

(22) PCT Filed: Apr. 26, 2017
(86) PCT No.: PCT/US17/29615

§ 371 Date: Oct. 26, 2019

(51) Int. Cl. A41B 15/00; B32B 7/12; B32B 5/26

(52) U.S. Cl. CPC A41B 15/00; B32B 7/12; B32B 2307/73; B32B 2307/726; B32B 5/26

(57) ABSTRACT

The present invention generally relates to a handkerchief system and a method to use it that are effective in preventing the soiling of an individual's hand or hands during coughing, sneezing or blowing his or her nose due to seeping of infected particles and liquids that are expelled while coughing, sneezing or blowing or wiping his or her nose.

### FIELD OF THE INVENTION

The present invention generally relates to personal handkerchiefs, and more particularly to handkerchiefs and methods of using them that are effective in preventing contact of the individual's hand or hands with the particles and liquids expelled while coughing, sneezing or blowing or wiping his or her nose.

### BACKGROUND OF THE INVENTION

Traditional handkerchiefs are typically squares made of soft absorbent cloth material such as cotton, synthetic blend, or linen, and used for personal hygiene when a user coughs or sneezes or has a running nose, and needs to blow or wipe his or her nose. Facial tissues, in contrast, are absorbent and disposable thin papers, suitable for use to clean the face. Both, handkerchiefs and facial tissues, are easily soaked and saturated with mucus, phlegm or sputum, and do not effectively protect the user's hands from contamination because the mucus can easily seep to the other side of the handkerchief or tissue. Disposable facial tissues have the added problem of easily tearing during use.

Traditional handkerchiefs are designed for multiple uses, and as such, may become infested with germs, which increase the possibility that viruses and bacteria will be spread. Viruses can easily survive in a handkerchief, and even if the user prefers disposable facial tissues, the normal handling of the facial tissues before discarding them may be enough to contaminate the users hand or hands. Because of the saturation, and possible tearing, users can easily end up with their hands contaminated with nasal mucus, phlegm, sputum, or other body fluids.

Handkerchiefs and facial tissues are typically symmetrical and made of one material in one color. Thus, when a person uses a handkerchief or a facial tissue, the possibility of inadvertently touching a soiled surface is significant, even if the user is careful when folding it.

Once an infected individual has soiled his hands with mucus, phlegm, sputum, and other potentially infectious liquids, he can transfer that infectious material when he shakes his hands with a non-infected individual who may then use his hands to touch his own mucous membrane; consequently, getting infected. Alternatively, the infected individual may touch an object such as telephone, door knob, writing instrument, currency, etc., which a non-infected person could touch later and carry residues of the mucus, phlegm, or sputum, or other potentially infectious liquids to his own mucous membrane; consequently, getting infected. Thus, it is important to contain the spread of mucus, phlegm, sputum, and potentially infectious liquids, which may carry diseases, and create an effective barrier by preventing the soiling of an individual's hands during coughing, sneezing or blowing or wiping his nose.

Therefore, there is a long-standing and unmet need for a handkerchief or facial tissue product that can act as an effective barrier protect the user's hands from becoming contaminated with nasal mucus, phlegm, sputum, or other body fluids and consequently prevent the spreads of disease. The present invention fulfills this long-standing need in the art.

### SUMMARY OF PREFERRED EMBODIMENTS

The invention is a handkerchief system that comprises a three-layer handkerchief in which the middle layer is water-repellant, and acts as an effective barrier against seeping mucus, phlegm, sputum, and potentially infectious liquids that may carry diseases. A preferred embodiment of the invention allows the user to further avoid contact of his/her hands with particles and liquids that are expelled while coughing, sneezing, or blowing or wiping his or her nose. This is preferably achieved when the handkerchief is folded following the method described such that the user hands never touch the surfaces of the handkerchief that get in contact the user's nose and mouth.

According to a preferred non-limiting embodiment, a disposable handkerchief system to prevent contact of the individual's hand or hands with the particles and liquids expelled while coughing, sneezing, or blowing or wiping his or her nose comprises:
(i) a first tissue liner;
(ii) a base layer;
(iii) a second tissue liner; and
(iv) a pouch.

According to another preferred non-limiting embodiment, the first tissue liner and second tissue liner are made of soft and absorbent material.

According to another preferred non-limiting embodiment, the base layer is made of water-repellant material.

According to another preferred non-limning embodiment, the pouch is made of water-repellant material.

According to another preferred non-limiting embodiment, the base layer is placed in between the first tissue liner and second tissue liner.

According to another preferred non-limiting embodiment, the first tissue liner and second tissue liner are joined to opposite sides of the base layer, or sewn, or kepi together with adhesive, or welding, or other suitable means.

According to another preferred non-limiting embodiment, the area of the pouch is approximately ⅛ of the area of the second tissue liner.

According to another preferred non-limiting embodiment, the pouch is attached onto the second tissue liner and located proximate to one of its corners.

According to another preferred non-limiting embodiment, the first tissue liner is marked with numeral “1” and the minor image of numeral “1.”

According to another preferred non-limiting embodiment, the second tissue liner is marked with numerals “2”, mirror image of numeral “2”, “3”, mirror image of numeral “3”, the word “INSERT” and an arrow.

According to another preferred non-limiting embodiment, the numerals and other marks are replaced with symbols.

According to another preferred non-limiting embodiment, the handkerchief is inserted and stored inside the pouch.

According to another preferred non-limiting embodiment, the pouch comprises cords, buttons, Velcro, adhesive, or other fastening means to close it, and keep it closed and secured.

According to another preferred non-limiting embodiment, a method of preventing contact of the individual's hand or hands with the particles and liquids expelled while coughing, sneezing, or blowing or wiping his or her nose comprising:
after a user has blown their nose and expelled the contents onto the first tissue liner of the handkerchief, the user then folds the handkerchief along the middle vertical crease, left to right, connecting the number “1” to its mirror image number “1” and leaving the second tissue liner visible;
rotating the handkerchief ninety (90) degrees clockwise;
folding the handkerchief along a middle vertical crease on the second tissue liner, left to right, connecting the number “2” to its mirror image number “2”.
folding the handkerchief along the horizontal crease, connecting the number “3” to its mirror image number “3”; and
the user then tucking the handkerchief into the protective pouch.

In a further preferred non-limiting embodiment, after a user performs the method as described above, the user then discards the entire protective pouch that contains the handkerchief tucked therein.

In the Summary above, in the Description and the Claims below, and in the accompanying drawings, reference is made to particular features, including method steps, of the invention. For example, where a particular feature is disclosed in the context of a particular aspect, or embodiment of the invention, or a particular claim, that feature can also be used, to the extent possible, in combination with and/or in the context of other particular aspects and embodiments of the invention, and in the invention generally. Still other objects and advantages of preferred embodiments of the present invention will become readily apparent to those skilled in this art from the following detailed description, wherein there is described certain preferred embodiments of the invention, and examples for illustrative purposes.

### BRIEF DESCRIPTION OF THE DRAWINGS

The previously mentioned features and advantages of the invention, as well as others, will become clearer as a result of the following detailed description in relation to the attached schematic drawings, wherein:

FIG. 1 shows a first tissue liner 110 on the front view of the Hankz Tuckable Tissue 100.

FIG. 2 shows a two-sided base layer 120 of the Hankz Tuckable Tissue 100, made of soft, breathable, durable, and water repellant material such as SMS non-woven fabric.

FIG. 3 illustrates the first tissue liner 110 on the front view of the Hankz Tuckable Tissue 100 with a numeral “1” and a mirror image of numeral “1” marked.

FIG. 4 shows the back view of the Hankz Tuckable Tissue 100, illustrating a second tissue liner 130 marked with numerals “2”, mirror image of numeral “2”, “3”, mirror image of numeral “3”, the word “INSERT” and an arrow; and a pouch 140.

FIGS. 5 through 11 illustrate the steps to use, fold and tuck the Hankz Tuckable Tissue 100.

### DETAILED DESCRIPTION OF PREFERRED EMBODIMENTS

The present invention provides several configurations of, and methods of folding and disposing of, the “Hankz Tuckable Tissue” Handkerchief System so that it can effectively prevent the soiling of an individual's hand or hands during coughing, sneezing, or blowing or wiping his or her nose, and that are also effective in substantially preventing contamination of the environment by infectious particles and infectious liquids that are released while coughing, sneezing, or blowing or wiping one's nose.

As used herein, the “Hankz Tuckable Tissue” Handkerchief System is intended to refer to a significant feature of the present invention, wherein combination of different features of the present invention are effective in catching, or capturing, and retaining, all or substantially all of the particles, liquids and any other materials, including but not limited to infectious particles and infectious liquids, that are released and dispersed, due to coughing, sneezing, or blowing or wiping one's nose. In the process of catching, or capturing, and retaining, all, or substantially all, of the particles, liquids and any other materials, including but not limited to infectious particles and infectious liquids, the numerous devices and systems of the present invention are effective in preventing tire soiling of an individual's hand or hands during coughing, sneezing or blowing or wiping his or her nose.

Certain preferred and non-limiting embodiments of the invention are described herein.

### “Hankz Tuckable Tissue” Handkerchief System

According to one preferred embodiment, the present invention provides a handkerchief system for substantially preventing contamination and substantially reducing the spread of infectious particles and infectious liquids when an individual is coughing, sneezing, or blowing or wiping his or her nose. The present invention also provides a method comprising the use of this “Hankz Tuckable Tissue” Handkerchief System that substantially prevents contamination of the individual's hands and that also substantially prevents contamination of the environment by infectious particles and infectious liquids that are released and dispersed due to coughing, sneezing, or blowing or wiping one's nose, etc.

Preferably, a “Hankz Tuckable Tissue” Handkerchief System is effective in containing infectious particles and avoiding the soiling of the user's hand or hands while coughing, sneezing or blowing or wiping the user's nose, or a combination thereof.

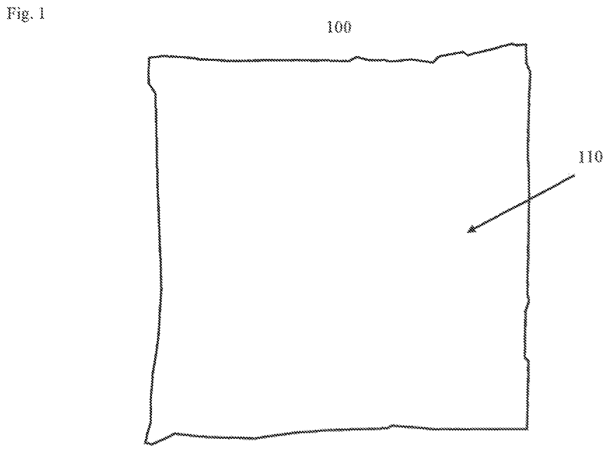

FIG. 1 shows a first tissue liner 110 on the front view of the Hankz Tuckable Tissue 100.

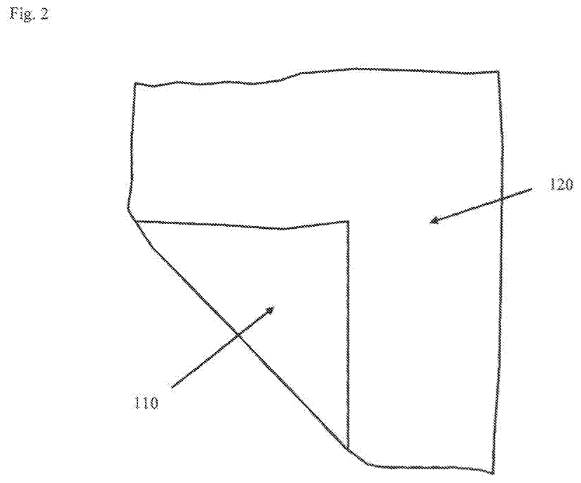

FIG. 2 shows a two-sided base layer 120 of the Hankz Tuckable Tissue 100, made of soil, breathable, durable, and water repellant material such as SMS non-woven fabric.

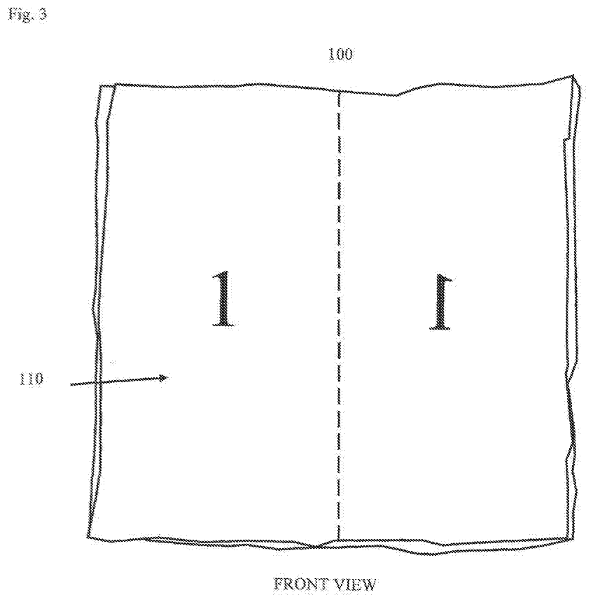

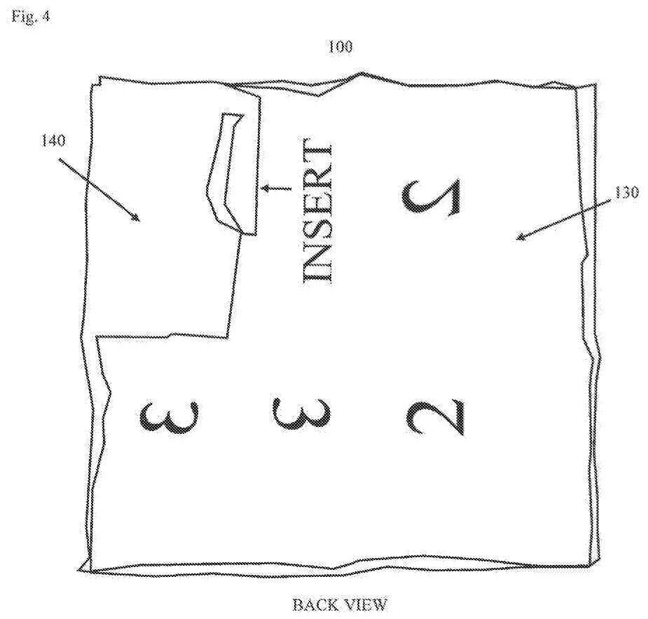

FIGS. 3 and 4 illustrate the front and back views, respectively, of a preferred embodiment of a representative “Hankz Tuckable Tissue” Handkerchief System described herein, comprising a first tissue liner 110 and a second tissue liner 130, one on each side of the two-sided base layer 120 which is made of a soil, breathable, durable, and water repellant material such as SMS non-woven fabric. Further detailed description of the elements of a representative “Hankz Tuckable Tissue” Handkerchief System is provided below.

According to a preferred non-limiting embodiment, a representative “Hankz Tuckable Tissue” Handkerchief System comprises:
(i) a first tissue liner 110 made of a soft and absorbent material, on one side of a base layer 120;
(ii) the base layer 120 made of soft, breathable, durable, and water repellant material such as SMS non-woven fabric, which has a top surface and a bottom surface; and
(iii) a second tissue liner 130 made of a soft and absorbent material, on the other side of the base layer 120.

According to another preferred non-limiting embodiment, the first tissue liner 110 is made of a soft and absorbent material, on one side of the base layer 120, and is marked with the numerals “1” and the mirror image of numeral “1.”

According to another preferred non-limiting embodiment, the second tissue liner 130 is marked with the numerals “2”, “the mirror image of numeral “2”, “3”, the mirror image of numeral “3”, the word “INSERT” and an arrow.

According to another preferred non-limiting embodiment, the second tissue liner 130 has a pouch 140 located proximate to one corner of the second tissue liner 130.

According to another preferred non-limiting embodiment, the attached pouch 140 has an area of approximately ⅛ of the total area of the second tissue liner 130.

According to another preferred non-limiting embodiment, live pouch 140 is sewn, or adhered, or welded to the second tissue liner 130, or attached using other suitable means.

According to another preferred non-limiting embodiment, the first liner 110, the base layer 120 and the second tissue liner 130 are sewn together, or kept together with adhesive or welding or other suitable means.

According to another preferred non-limiting embodiment, the “Hankz Tuckable Tissue” 100 is made of only one layer, and such layer is internally water repellant, and its top and bottom surfaces are soft and absorbent.

In another preferred non-limiting embodiment, said Hankz Tuckable Tissue 100 is folded and inserted and stored inside the pouch 140.

In yet another preferred non-limiting embodiment, said pouch 140 is made of water repellant material.

In yet another preferred non-limiting embodiment, said numerals “1”, “2”, “3”, mirror image of numeral “1”, mirror image of numeral “2”, mirror image of numeral “3”, the word “INSERT,” and the arrow are replaced with other symbols, marks, images, figures, or similar, or none.

In yet another preferred non-limiting embodiment, the “Hankz Tuckable Tissue” Handkerchief System has cords, buttons. Velcro, adhesive, or other means to close it, and keep it closed find secured.

The “Hankz Tuckable Tissue” Handkerchief System is designed so that an individual can cover one's mouth, nose or both to contain expelled particles during coughing, sneezing, blowing or wiping his or her nose or a combination thereof without contaminating his or her hands or the surrounding air.

In another preferred embodiment, the Hankz Tuckable Tissue 100 comprises non-woven, breathable, water-resistant fabric for either the first tissue liner 110, the second tissue liner 130, or a combination thereof.

In yet other preferred embodiments, any suitable type of joining or melting technologies or processes, such as heat transfer process can be used, for instance, to join or melt the tissue liners 110 and 130 onto the base layer 120. Further, any suitable type of adhesive can be used to join or fasten the tissue liners 110 and 130 onto the base layer 120 together.

In one example, the base layer 120 which is made of a water-repellant fabric or something similar, and the tissue liners 110 and 130 which are made of a soft and absorbent material, are square-shaped, and approximately the same size, but it is to be understood that these components can be of any suitable shape and size, and have any suitable length and width and other dimensions.

In a related embodiment, the Handkerchief System comprises any means or mechanism for securely containing mucus, phlegm, sputum, or other body fluids ejected while sneezing, coughing, or while blowing or wiping one's nose and avoiding contamination of the user's hands or contamination of the environment by infectious particles and infectious liquids that are released while coughing, sneezing, or blowing or wiping one's nose.

Although the non-limiting embodiment of, and the method of using, the Hankz Tuckable Tissue 100 disclosed herein, show three folding steps, it is to be understood that any number of folding steps can be done with the present invention. In other embodiments, the Hanks Tuckable Tissue 100 can be designed to have no folds.

FIG. 1 illustrates the first tissue liner 110 which is made of a soft and absorbent material on a representative Hankz Tuckable Tissue 100. The Hankz Tuckable Tissue 100 can be a square shape, although other forms may also be used.

FIG. 2 illustrates an inner construction detail showing the base layer 120, which is made of a water repellent material, and it is adhered to the first tissue liner 110.

FIG. 3 illustrates the first tissue liner 110 on the front view of the Hankz Tuckable Tissue 100.

FIG. 4 show s the reverse side of the Hankz Tuckable Tissue 100 with the second tissue liner 130 and the pouch 140 proximate to one corner. The second tissue liner 130 is preferably made of soil and absorbent material, and it is adhered to the base layer 120. The pouch 140 is preferably made of water repellant material, and it may have an attached cord, button, Velcro, adhesive, etc. to ensure it can be securely closed when all the folding steps have been performed, and the Hankz Tuckable Tissue 100 has been inserted into it.

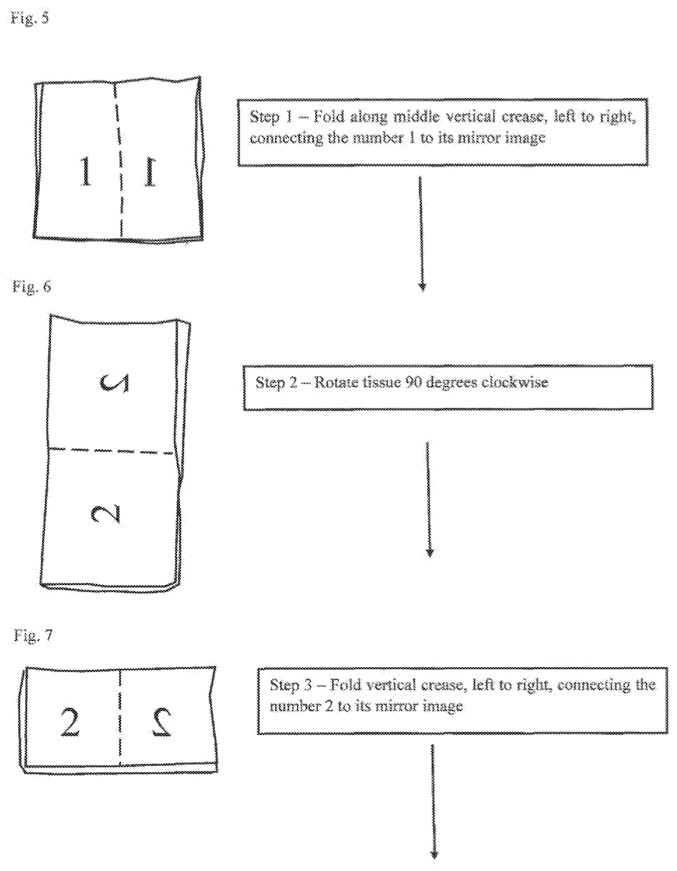

FIG. 5 shows the starting position of the Hankz Tuckable Tissue 100 with the numeral “1” and the mirror image of numeral “1” visible, before a first folding step.

FIG. 6 shows the Hankz Tuckable Tissue 100 after the first folding step with the numeral “2” and the mirror image of numeral “2” visible.

FIG. 7 illustrates the Hankz Tuckable Tissue 100 after a 90-degree clockwise rotation, and before a second folding step.

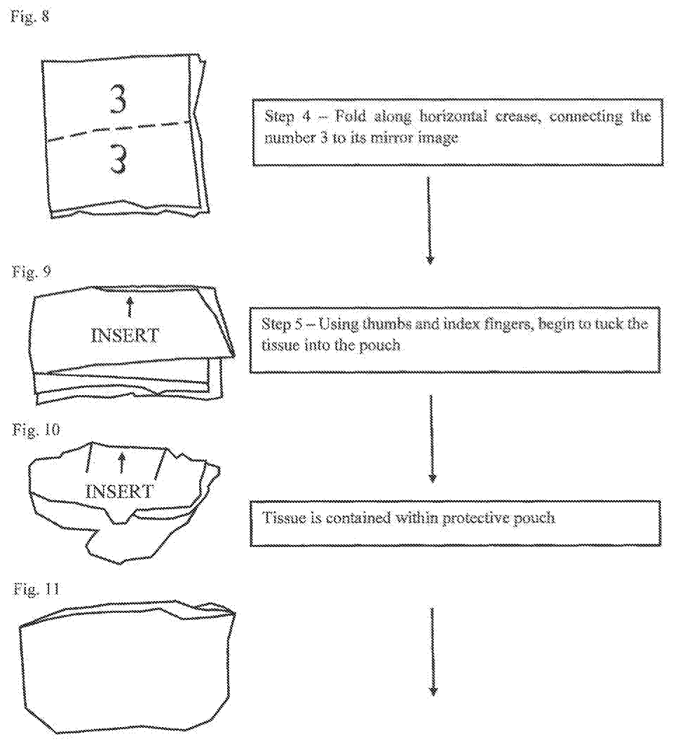

FIG. 8 illustrates the Hankz Tuckable Tissue 100 after the second folding step with the numeral “3” and the mirror image of numeral “3” visible, and before a third folding step.

FIG. 9 illustrates the Hankz Tuckable Tissue 100 after the third folding step with the word “INSERT” and a vertical arrow above it marked.

FIG. 10 shows the Hankz Tuckable Tissue 100 being tucked inside the pouch 140.

FIG. 11 shows the Hankz Tuckable Tissue 100 contained inside its pouch 140, and ready for disposal.

### Preferred, Non-Limiting Method of Using the “Hankz Tuckable Tissue” Handkerchief System

In yet another preferred non-limiting embodiment, a method of using the “Hankz Tuckable Tissue” 100 to prevent the soiling of an individual's hand or hands during coughing, sneezing, or blowing or wiping his or her nose, and to substantially prevent contamination of the environment by infectious particles and infectious liquids that are released while coughing, sneezing, or blowing or wiping one's nose, comprises:
Step 1: After a user has sneezed, coughed or blown or wiped their nose and expelled the contents onto the surface of the first tissue liner 110, the user then folds the Hankz Tuckable Tissue 100 along the middle vertical crease, left to right, connecting the numeral “1” to its minor image of numeral “1”.
Step 2: The user now views the second tissue liner 130 with numeral “2” and its mirror image “2” marked. The user may then rotate the “Hankz Tuckable Tissue” Handkerchief System ninety (90) degrees clockwise.
Step 3: Optionally, the user may again cough or sneeze, blow or wipe their nose and expel the contents onto the exposed surface of the second tissue liner 130.
Step 4: The user then folds the Hankz Tuckable Tissue 100 along the middle vertical crease, left to right, connecting the numeral “2” to the mirror image of numeral “2”.
Step 5: Optionally, the user may again cough or sneeze, blow or wipe their nose and expel the contents onto the exposed surface of the second tissue liner 130.
Step 6: The user then folds along the horizontal crease, connecting the numeral “3” to the minor image of numeral “3”.
Step 7: Optionally, the user may then use the exposed surface of the second tissue liner 130 for clean up or to wipe up their face.
Step 8: The user then uses their thumbs and index fingers, and begins to tuck the Hankz Tuckable Tissue 100 by pressing where the word “INSERT” is marked into the pocket of the pouch 340.
Step 9: The user then disposes of the used “Hankz Tuckable Tissue” Handkerchief System.

The present invention surprisingly creates a handkerchief system that can act as an effective barrier to prevent the spread of mucus, phlegm, sputum, and potentially infectious liquids, which may carry diseases, by preventing the soiling of an individual's hands during coughing, sneezing or blowing or wiping his nose.

Although the present invention has been described in considerable detail with reference to certain preferred embodiments, other embodiments am possible and within the scope of the invention. Therefore, the spirit and scope of the invention should not be limited to the description contained herein.

What is claimed is:

1. A disposable handkerchief system to prevent contact of the individual's hand or hands with the particles and liquids expelled while coughing, sneezing or blowing or wiping his or her nose comprising:
(i) a first tissue liner;
(ii) a base layer;
(iii) a second tissue liner; and
(iv) a pouch.

2. The system of claim 1, wherein the first tissue liner and second tissue liner are made of soft and absorbent material.

3. The system of claim 1, wherein the base layer is made of water-repellant material.

4. The system of claim 1, wherein the pouch is made of water-repellant material.

5. The system of claim 1, wherein the base layer is placed in between the first tissue liner and second tissue liner.

6. The system of claim 1, wherein the first tissue liner and second tissue liner are joined to opposite sides of the base layer, or sewn, or kept together with adhesive, or welding, or other suitable means.

7. The system of claim 1, wherein the area of the pouch is approximately ⅛ of the area of the second tissue liner.

8. The system of claim 1, wherein the pouch is attached onto the second tissue liner and located proximate to one of its corners.

9. The system of claim 1, wherein the first tissue liner is marked with numeral “1” and the mirror image of numeral “1.”

10. The system of claim 1, wherein the second tissue liner is marked with numerals “2”, mirror image of numeral “2”, “3”, mirror image of numeral “3”, the word “INSERT” and an arrow.

11. The system of claim 1, wherein the numerals and other marks are replaced with symbols.

12. The system of claim 1, wherein the handkerchief is inserted and stored inside the pouch.

13. The system of claim 1, wherein the pouch comprises cords, buttons, Velcro, adhesive, or other fastening means to close it, and keep it closed and secured.

14. A method of preventing contact of the individual's hand or hands with the particles and liquids expelled while coughing, sneezing or blowing or wiping his or her nose comprising:
after a user has blown their nose and expelled the contents onto the first tissue liner of the handkerchief, the user then folds the handkerchief along the middle vertical crease, left to right, connecting the number “1” to its mirror image number “1” and leaving the second tissue liner visible;
rotating the handkerchief ninety (90) degrees clockwise;
folding the handkerchief along a middle vertical crease on the second tissue liner, left to right, connecting the number “2” to its mirror image number “2”,
folding the handkerchief along the horizontal crease, connecting the number “3” to its mirror image number “3”; and
the user then tucking the handkerchief into the protective pouch.
